(19) United States
(12) Patent Application Publication
(10) Pub. No.: US 2007/0289155 A1
(43) Pub. Date: Dec. 20, 2007

(54) Measuring tape and pencil sharpener

(76) Inventor: Allan C. Winemiller, Columbia, SC (US)

Correspondence Address: JAMES RAY & ASSOCIATES, 2640 PITCAIRN ROAD, MONROEVILLE, PA, 15146, US

(21) Appl. No.: 11/810,787

(22) Filed: Jun. 7, 2007

Related U.S. Application Data
(60) Provisional application No. 60/814,283, filed on Jun. 19, 2006.

(51) Int. Cl. G01B 3/10

(52) U.S. Cl. 33/760

(57) ABSTRACT

A combination measuring tape and pencil sharpener has a removable sharpening unit to provide a convenient field sharpener. A conventional retractable measuring tape is combined with pencil sharpener unit. The removable sharpener unit frictionally engages the measuring tape housing. Sharpener unit is located in an opening in the rear of the measuring tape housing and the shavings are discharged from an opening in the housing bottom positioned under the sharpening unit blade. The sharpening units can be replaced when worn or to accommodate a round or carpenter's pencil.

### CROSS REFERENCE TO RELATED APPLICATION

This patent application is related to and claims priority from U.S. Provisional Patent Application Ser. No. 60/814,283 filed Jun. 19, 2006.

### FIELD OF THE INVENTION

The present invention relates, in general, to a combination tool and, more particularly, this invention relates to a combination measuring tape and pencil sharpener.

### BACKGROUND OF THE INVENTION

Prior to the conception and development of the present invention, as is generally well known in the prior art, is a combination of a measuring tape and pencil sharpener. Prior inventions have placed the sharpener in the top of the sharpener aligned about the vertical axis of the tape housing or aligned along the longitudinal axis of the tape housing either at adjacent to the top or bottom of the housing. The sharpeners have either had a chamber for the collection of shavings or a discharge opening. The sharpener blade, where removable, has been attached with a screw to the housing. In the prior sharpener measuring tape combinations, the sharpener was designed to accommodate only one type of pencil, round or carpenters.

### SUMMARY OF THE INVENTION

The present invention provides a combination measuring tape pencil sharpener the sharpener is one unit and is removable from the housing of the measuring tape. The sharpener frictionally engages and opening in the tape housing and is removable. When the sharpener is worn, it can be removed from the housing and replaced with a new sharpener unit. The sharpener unit has a opening to received the pencil and a sharpening blade. The opening sharpening unit in preferred embodiment can have a generally conical shape to receive a round pencil or a cross shaped opening to receive a carpenter's pencil. Alternative sharpeners to receive a carpenter's pencil or round pencil can be inserted. The housing of the measuring tape has three opening. These openings are an opening to receive the measuring tape, an opening for the sharpener unit and an opening to discharge the pencil shavings. In the preferred embodiment, the opening for the sharpening unit is disposed in the rear portion of the tape housing generally near the bottom portion. The discharge opening is disposed in the bottom portion below the sharpener blade. The opening in the bottom of the housing permits a smooth surface and does not interfere with the operation of the tape.

The measuring tape is wound about a reel mounted in the housing and is retractable.

### OBJECTS OF THE INVENTION

It is, therefore, one of the primary objects of the present invention to provide an accessible pencil sharpener in a tape measure.

Another object of the present invention is to provide a combination measuring tape and sharpener in which the entire sharpener can be conveniently replaced

Still another object of the present invention is to provide a sharpener that can accommodate a round and carpenter's pencil.

Yet another object of the present invention is to provide a combination measuring tape and pencil sharpener that provides a generally flat bottom surface for measuring.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the combination measuring tape and pencil sharpener.

FIG. 2 is a perspective view with the sharpener removed from the measuring tape housing.

FIG. 3 is a pencil sharpener with a cross shaped pattern.

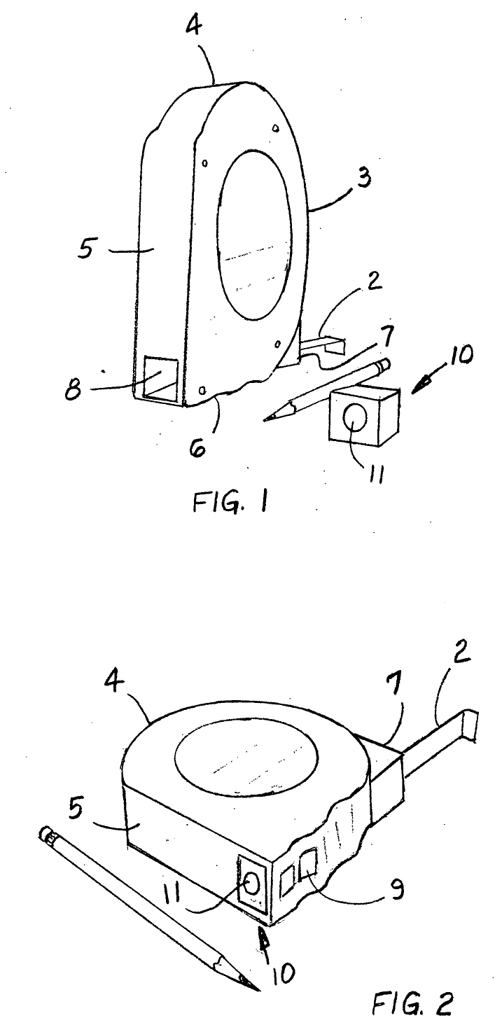

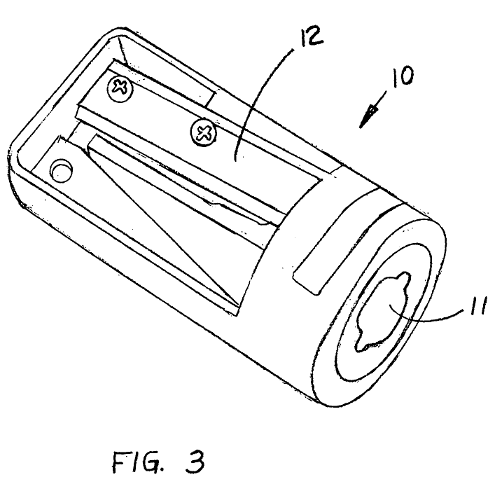

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

Reference is now made, more particularly, to FIG. 1 a housing 1 encloses a conventional measuring tape 2 wound on a reel (not shown). The housing has a forward portion 3, top portion 4, rear portion 5 and bottom portion 6. The housing has three openings, a tape exit opening 7, sharpener opening 8 and discharge opening 9. The tape exit opening 7 is located in the forward portion 3 of the housing 1. The sharpener opening 8 is preferably located in the rear portion 5 of housing 1 a predetermined elevation from the intersection of the rear portion 5 and bottom portion 6. The discharge opening 9 located in the bottom portion a predetermined distance.

The sharpener 10 has an opening 11 for insertion of a pencil. The pencil is urged against blade 12 shaving wood and pencil lead to form a point. The shavings are discharged through discharge opening 9.

In the preferred embodiment the sharpener 10 is inserted into the sharpener opening 8 and is frictionally engaged by the interior of sharpener opening 8. The sharpener is removable and can be replaced when worn. For a round pencil the opening 11 is generally conical. The sharpener 10 can also have an opening 11 which as shown in FIG. 3 can accommodate a carpenter's pencil. The combination measuring tape and sharpener thus permits the flexibility of use in the field for either pencil.

The field use gives allows the operator the convenience of a sharpener without having a separate sharpener.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A combination tape measure and pencil sharpener comprising:
a housing with a top portion, front portion, bottom portion and rear portion having a predetermined shape, a spindle, an tape opening, a sharpener opening and a discharge opening in which said tape opening is positioned in the front portion of said housing, said sharpener opening is positioned in the rear portion of said housing and said discharge opening is positioned in the bottom portion of said housing;
a reel mounted to said housing
a tape, with a proximal and distal end, wound around said reel, threaded through said tape opening, having a generally right angle flange on said distal end, where said right angle flange than said tape opening;
a retracting means for said tape attached to said spindle;
a pencil sharpener frictionally engages said sharpener opening of said housing, said sharpener has an opening of a predetermined shape with, a blade, where said sharpener is such that a pencil urged against said blade shaving wood and pencil lead to form a sharpened pencil and where said wood shavings are discharged from said discharge opening of said housing.

2. An apparatus according to claim 1 in which said sharpener opening shape is generally conical and said blade is mounted generally along the longitudinal axis of said sharpener.

3. An apparatus according to claim 1 in which said sharpener opening shape is generally cross shaped and said blade is a draw blade mounted generally perpendicular to the longitudinal axis of said sharpener.

4. An apparatus according to claim 1 in which said retracting means is a spring.

5. A combination tape measure and pencil sharpener comprising:
a housing with a top portion, front portion, bottom portion and rear portion having a predetermined shape, a spindle, an tape opening, a sharpener opening and a discharge opening in which said tape opening is positioned in the front portion of said housing, said sharpener opening is positioned in the rear portion of said housing at a predetermined elevation from the bottom portion said housing and said discharge opening is positioned in the bottom portion of said housing generally below said knife;
a reel mounted to said housing;
a tape, with a proximal and distal end, wound around said reel, threaded through said tape opening, having a generally right angle flange on said distal end, where said generally right angle flange is wider than said first opening;
a retracting means for said tape attached reversibly biasing said reel;
a pencil sharpener frictionally engages said sharpener opening of said housing and is removable, said sharpener has an opening of a predetermined shape with, a blade, where said sharpener is such that a pencil urged against said blade shaving wood and pencil lead to form a sharpened pencil and where said wood shavings are discharged from said discharge opening of said housing.

6. An apparatus according to claim 5 in which said sharpener opening shape is generally conical and said blade is mounted generally along the longitudinal axis of said sharpener.

7. An apparatus according to claim 5 in which said sharpener opening shape is generally cross shaped and said blade is a draw blade mounted generally perpendicular to the longitudinal axis of said sharpener.

8. An apparatus according to claim 5 in which said retracting means is a spring.
